(19) United States
(12) Patent Application Publication
(10) Pub. No.: US 2025/0122061 A1
(43) Pub. Date: Apr. 17, 2025

(54) PLATFORM SYSTEM

(71) Applicant: SAMSUNG ELECTRONICS CO., LTD, Suwon-si (KR)

(72) Inventors: DAEWOONG HAN, Suwon-si (KR); SEUNGYEON KIM, Suwon-si (KR); Minsu CHANG, Suwon-si (KR); JUN-WON JANG, Suwon-si (KR); TAESIN HA, Suwon-si (KR)

(73) Assignee: SAMSUNG ELECTRONICS CO., LTD, Suwon-si (KR)

(21) Appl. No.: 18/908,258

(22) Filed: Oct. 7, 2024

(30) Foreign Application Priority Data
Oct. 16, 2023 (KR) 10-2023-0137595

(51) Int. Cl. B66F 11/04; B66C 3/00; B66F 17/00

(52) U.S. Cl. CPC B66F 11/04; B66C 3/005; B66F 17/006

(57) ABSTRACT

A platform system includes a station including a moving portion and a guide configured to guide movement of the moving portion, and a manipulator configured to pick up an object from the moving portion or to place the object on the moving portion, where the moving portion is configured to move in response to the manipulator picking up the object from the moving portion or placing the object on the moving portion.

### CROSS-REFERENCE TO RELATED APPLICATION

This application is based on and claims priority to Korean Patent Application No. 10-2023-0137595, filed on Oct. 16, 2023, in the Korean Intellectual Property Office, the disclosure of which is incorporated by reference herein in its entirety.

### BACKGROUND

### 1. Field

The disclosure relates to a platform system.

### 2. Description of Related Art

Automated platforms including a robot, linear motion guide, and conveyor belt have been developed to transfer an object, such as equipment and a reagent, to a specific location. The equipment and reagent may be stored in a carrier such as a tray in a unit of determined numbers on an automated platform and may be subsequently transferred to a holding location in process equipment. The carrier may be loaded to specific process equipment by a robot arm, and after a process is completed, may be unloaded back to the holding location and returned by the robot arm.

The above-mentioned background technology is possessed or acquired in the process of deriving this disclosure and is not necessarily known technology disclosed to the general public before the application of this disclosure.

### SUMMARY

Provided is a platform system including a manipulator and a station capable of stably picking up and/or placing an object.

Additional aspects will be set forth in part in the description which follows and, in part, will be apparent from the description, or may be learned by practice of the presented embodiments of the disclosure.

According to an aspect of the disclosure, a platform system may include a station including a moving portion and a guide configured to guide movement of the moving portion, and a manipulator configured to pick up an object from the moving portion or to place the object on the moving portion, where the moving portion is configured to move in response to the manipulator picking up the object from the moving portion or placing the object on the moving portion.

The moving portion may be further configured to move in a plane direction of the guide.

The moving portion may include a first plate.

The guide may include a second plate.

The moving portion may include a guide column.

The moving portion may be further configured to move from an original position and the guide may include an aligner configured to align the moving portion in the original position.

The aligner may include an elastic portion.

The aligner may include a hydraulic cylinder.

The aligner may include a gas spring.

The aligner may include an electromagnetic device.

The aligner may include a motor system.

The guide may include a stopper configured to absorb shock resulting from a collision of the moving portion with the stopper.

The moving portion may be further configured to move from an original position and the guide may include a plunger configured to fix a position of the moving portion to the original position.

The platform system may include a roller provided between the moving portion and the guide.

The manipulator may be configured to move relative to the station.

The manipulator may include a gripper configured to grip the object, the gripper including an inclined surface.

According to an aspect of the disclosure, a station may include a moving portion on which an object is placed, the moving portion being configured to move in response to the object being picked up from the moving portion or in response to the object being placed on the moving portion, and a guide configured to guide movement of the moving portion.

The moving portion may be further configured to move in a plane direction of the guide.

According to an aspect of the disclosure, a manipulator may include a gripper configured to grip an object, the gripper having an inclined surface, where the manipulator is configured to pick up the object from a station or place the object on the station using the gripper.

The manipulator may be further configured to move relative to the station.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a perspective view of a platform system according to an embodiment;

FIG. 2 is a perspective view of a station of a platform system, according to an embodiment;

FIG. 3 is an exploded perspective view of a station of a platform system, according to an embodiment;

FIG. 4 is a diagram illustrating an aligner of a station of a platform system, according to an embodiment;

FIG. 5 is a diagram illustrating a stopper of a station of a platform system, according to an embodiment;

FIG. 6 is a diagram illustrating a plunger of the station of the platform system, according to an embodiment;

FIG. 7 is a diagram illustrating a roller of a station of a platform system, according to an embodiment;

FIG. 8 is a diagram illustrating an operation in which a manipulator picks up an object in a platform system, according to an embodiment;

FIG. 9 is a diagram illustrating an operation in which a moving plate of a station moves in a platform system, according to an embodiment; and

FIG. 10 is a diagram illustrating an operation in which the moving plate returns to an original position of the moving plate to be aligned after an object is picked up in a platform system, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, platform systems are described in detail with reference to the accompanying drawings. However, various alterations and modifications may be made to the embodiments. The embodiments are not meant to be limited by the descriptions of the present disclosure. The embodiments should be understood to include all changes, equivalents, and replacements within the idea and the technical scope of the disclosure.

In the drawings, like reference numerals refer to like elements throughout and sizes of constituent elements may be exaggerated for convenience of explanation and the clarity of the specification. Also, embodiments described herein may have different forms and should not be construed as being limited to the descriptions set forth herein.

It will also be understood that when an element is referred to as being “on” or “above” another element, the element may be in direct contact with the other element or other intervening elements may be present. The singular forms include the plural forms unless the context clearly indicates otherwise. It should be understood that, when a part “comprises” or “includes” an element, unless otherwise defined, other elements are not excluded from the part and the part may further include other elements.

The use of the terms “a” and “an” and “the” and similar referents are to be construed to cover both the singular and the plural. The steps of all methods described herein can be performed in any suitable order unless otherwise indicated herein or otherwise clearly contradicted by context, and are not limited to the described order.

Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The use of any and all examples, or exemplary language (e.g., “such as”) provided herein, is intended merely to better illuminate the disclosure and does not pose a limitation on the scope of the disclosure unless otherwise claimed.

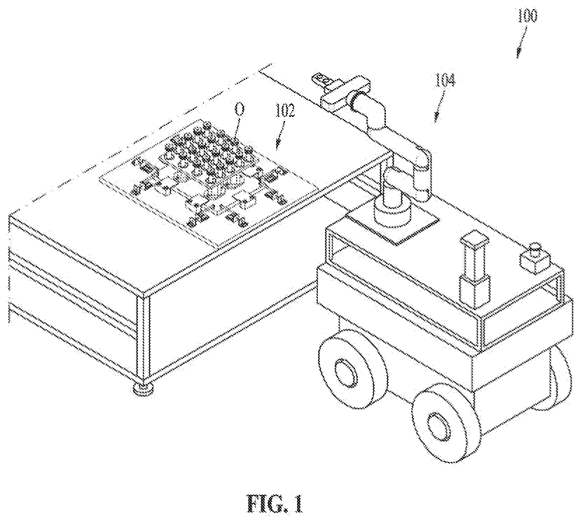

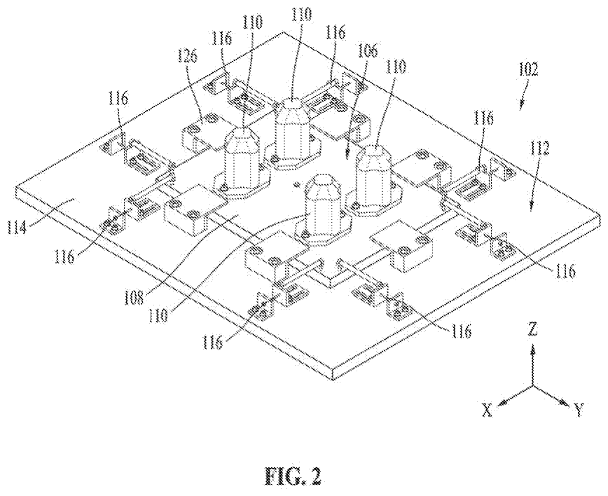

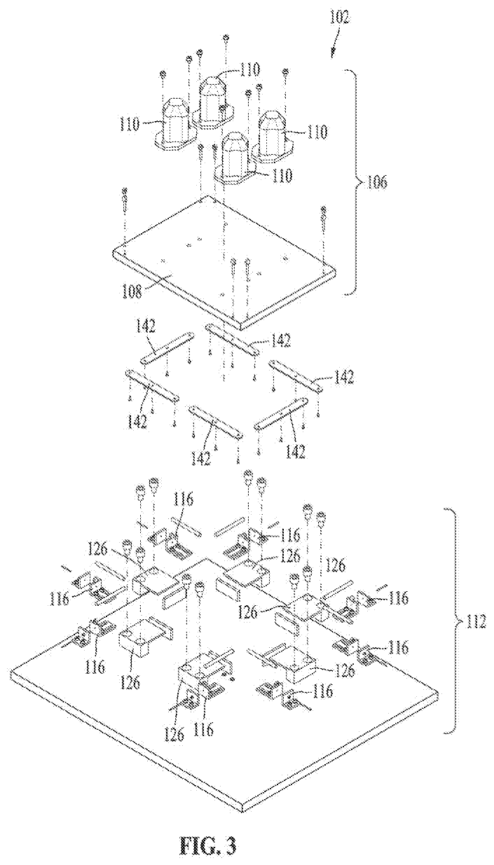

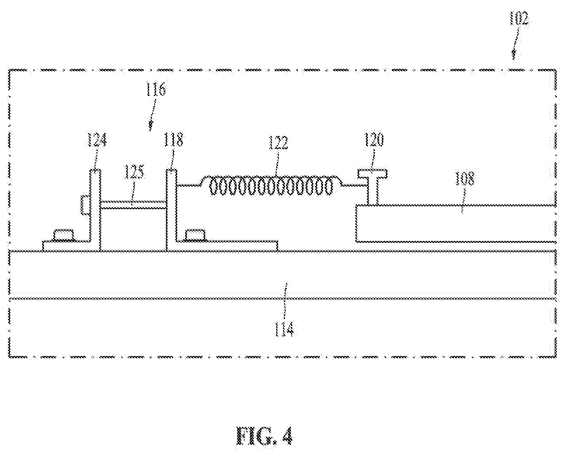

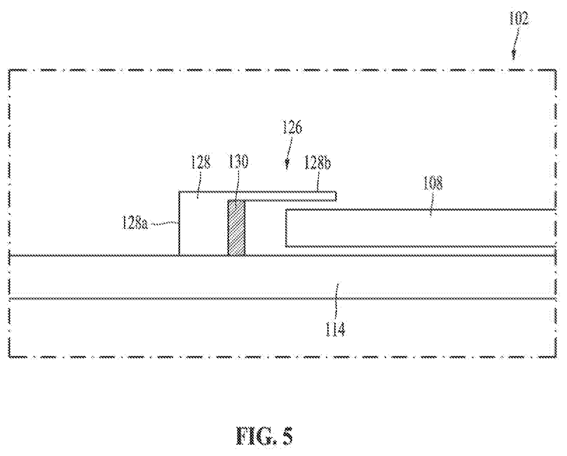

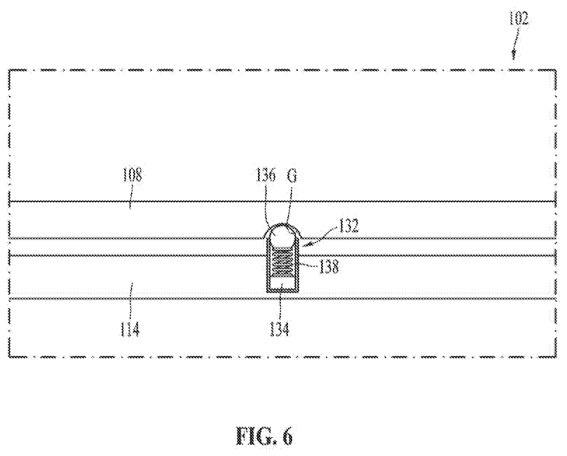

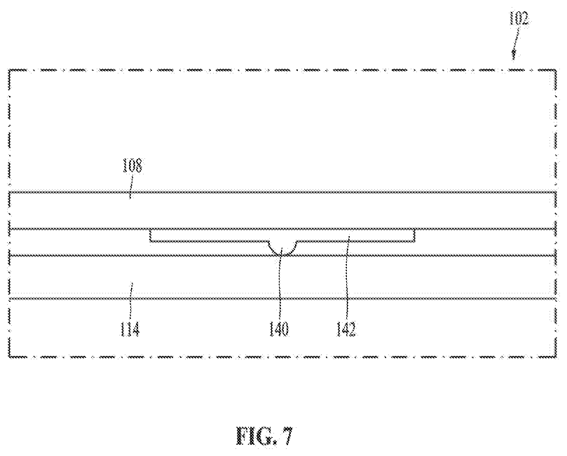

FIG. 1 is a perspective view of a platform system according to an embodiment. FIG. 2 is a perspective view of a station of a platform system, according to an embodiment. FIG. 3 is an exploded perspective view of a station of a platform system, according to an embodiment. FIG. 4 is a diagram illustrating an aligner of a station of a platform system, according to an embodiment. FIG. 5 is a diagram illustrating a stopper of a station of a platform system, according to an embodiment. FIG. 6 is a diagram illustrating a plunger of the station of the platform system, according to an embodiment. FIG. 7 is a diagram illustrating a roller of a station of a platform system, according to an embodiment.

Referring to FIGS. 1 to 7, a platform system 100 may transfer an object O from a station 102 and/or load the object O to the station 102 using a manipulator 104. The manipulator 104 may reduce or prevent deviation of the object O from a determined position. The deviation of the object O from the determined position may be due to deviation (e.g., a position error) of the manipulator 104 with respect to the station 102 that may occur when the object O is being picked up from the station 102 or when the object O is being placed on the station 102 in the platform system 100.

The platform system 100 may be implemented as a system for transferring and loading the object O, such as equipment, a reagent, etc., using the manipulator 104, such as a mobile robot, in an automated platform for preparation, synthesis, and/or evaluation. For example, the mobile robot may estimate a position based on simultaneous localization and mapping (SLAM) while moving from an initial position to a target position. The station 102 may reduce or remove uncertainty that may occur due to a structural error (e.g., slippage between a wheel and the ground, imbalance of the ground, etc.) and a non-structural error (e.g., sensor noise or a non-optimized parameter of an algorithm that uses signals measured by various sensors such as a light detection and ranging (LiDAR) sensor, an inertial measurement unit (IMU), an encoder, etc.) that may be present with the mobile robot in the platform system 100. Accordingly, the station 102 may allow the manipulator 104 to stably pick up or place the object O.

However, the platform system 100 is not limited thereto and may be implemented in additional configurations. For example, the platform system 100 may be applied to a manufacturing process, logistics system, an automated laboratory, etc., that transfers and loads objects, such as the object O, using the manipulator 104.

Referring to FIG. 2, the station 102 may include a moving portion 106. The moving portion 106 may move in a determined direction (e.g., a direction within an XY plane) by a deviation (e.g., a position error) of the manipulator 104 with respect to the station 102. The moving portion 106 may move as a result of a force applied from the manipulator 104 to the moving portion 106 when the manipulator 104 picks up the object O from the moving portion 106 or when the manipulator 104 places the object O on the moving portion 106.

The moving portion 106 may include a moving plate 108, which may also be referred to as a “first plate.” The moving plate 108 may provide an area in which the object O (e.g., a reagent) is placed. The moving plate 108 may support the object O.

The moving portion 106 may include a plurality of guide columns 110. The plurality of guide columns 110 may guide the object O (e.g., a tray on which vials are disposed). When the manipulator 104 picks up or places the object O, a force may be applied from the manipulator 104 to the plurality of guide columns 110 through the object O, and thus the moving plate 108, on which the plurality of guide columns 110 are disposed, may move in the direction of the applied force. The plurality of guide columns 110 may be separated from one another in an predetermined area on the moving plate 108 at predetermined intervals.

The station 102 may include a guide 112. The guide 112 may guide a movement of the moving portion 106 while the moving portion 106 moves by an external force (e.g., the force applied from the manipulator 104).

The guide 112 may include a guide plate 114, which may also be referred to as a “second plate.” The guide plate 114 may be disposed below the moving plate 108. A length of the guide plate 114 in a first direction (e.g., an X-direction) and a length of the guide plate 114 in a second direction (e.g., a Y-direction) may be greater than a corresponding length of the moving plate 108 in the first direction (e.g., the X-direction) and a corresponding length of the moving plate 108 in the second direction (e.g., the Y-direction).

The guide 112 may include a plurality of aligners 116. The plurality of aligners 116 may allow the moving plate 108 to move from an original position and return to the original position to be aligned.

Referring to FIG. 4, each of the plurality of aligners 116 may include a first fixing portion 118 (e.g., a first bracket) fixed on the guide plate 114, a second fixing portion 120 (e.g., a screw) fixed on the moving plate 108, and an elastic portion 122 (e.g., a spring or other biasing element) connected to the first fixing portion 118 and the second fixing portion 120. While an external force is applied to the moving plate 108 and the moving plate 108 moves in a specific direction, the elastic portion 122 may be compressed or stretched. When the external force applied to the moving plate 108 is reduced or removed, the elastic portion 122 may apply an elastic force to the moving plate 108 to cause the moving plate 108 to return to the original position of the moving plate 108.

Each of the plurality of aligners 116 may include a third fixing portion 124 (e.g., a second bracket) fixed on the guide plate 114 and an adjuster 125 (e.g., a screw) configured to adjust the distance between the first fixing portion 118 and the third fixing portion 124. The adjuster 125 may set an initial length and/or tension of the elastic portion 122 by adjusting the distance between the first fixing portion 118 and the third fixing portion 124.

The plurality of aligners 116 may be implemented in various ways in additional to or alternatively to an implementation utilizing an elastic method (i.e., the elastic portion 122). For example, the plurality of aligners 116 may include a hydraulic cylinder, a gas spring, an electromagnetic device (e.g., a coil and a magnet), a motor system (e.g., a motor and a sensor) based on specific control (e.g., proportional-integral-derivative (PID) control), or any other suitable alignment device.

Referring to FIGS. 2, 3 and 5, the station 102 may include a stopper 126. The stopper 126 may reduce shock caused by inertia and/or collision of the moving portion 106. The stopper 126 may include a limiter 128 that is disposed on the guide plate 114 and configured to limit a movement range of the moving plate 108. For example, the limiter 128 may have a vertical portion 128a extending in a direction substantially parallel to the normal direction of the guide plate 114 and a horizontal portion 128b extending in a direction substantially perpendicular to the normal direction of the guide plate 114. The stopper 126 may include a shock absorber 130 configured to absorb the shock of the moving plate 108 when colliding with the moving plate 108. The shock absorber 130 may extend along the vertical portion 128a of the limiter 128 from a top surface of the guide plate 114 to a bottom surface of the horizontal portion 128b of the limiter 128.

Referring to FIG. 6, the station 102 may include a plunger 132. The plunger 132 may fix the moving plate 108 in the original position. The plunger 132 may include a supporting portion 134 disposed on the guide plate 114, a ball 136 separated from the supporting portion 134, and an elastic element 138 (e.g., a compression spring) configured to elastically support the ball 136 relative to the supporting portion 134. The ball 136 may have rolling contact with the moving plate 108 while the moving plate 108 returns to the original position. The ball 136 may be at least partially accommodated in a groove G formed in one surface (e.g., a surface facing the guide plate 114) of the moving plate 108 when the moving plate 108 is in the original position, thereby allowing the moving plate 108 to remain in the original position.

Referring to FIGS. 3 and 7, the station 102 may include a roller 140. The roller 140 may reduce friction of the moving plate 108 against the guide plate 114. The roller 140 may be disposed between the moving plate 108 and the guide plate 114 and may have rolling contact with the guide plate 114. The roller 140 may be formed integrally with an elongated roller-supporting portion 142 that is disposed on the moving plate 108 as a separate component from the moving plate 108. However, embodiments are not limited thereto. The roller 140 may be formed integrally with the moving plate 108 without the roller-supporting portion 142.

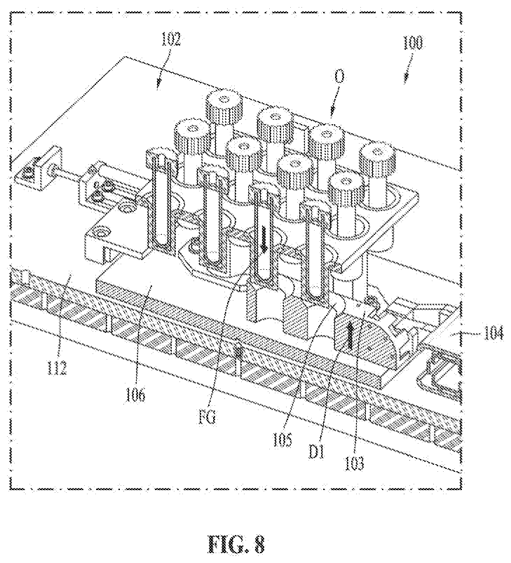

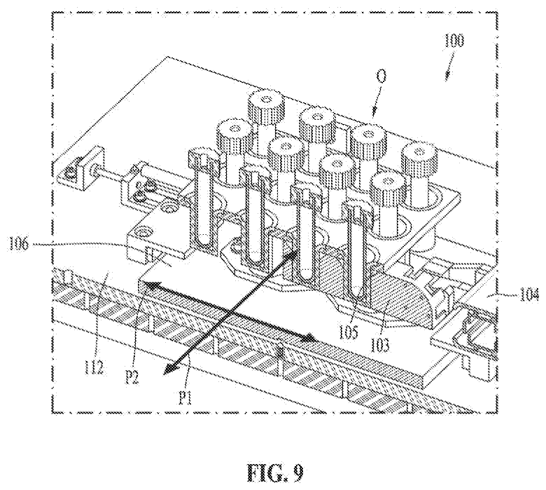

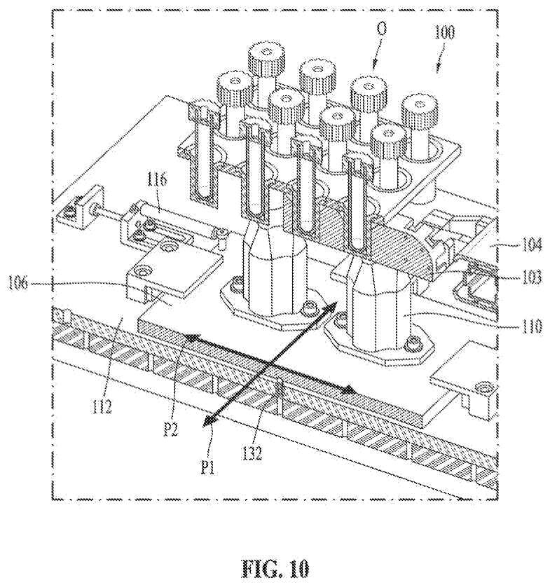

FIG. 8 is a diagram illustrating an operation in which a manipulator picks up an object in a platform system, according to an embodiment. FIG. 9 is a diagram illustrating an operation in which a moving plate of a station moves in a platform system, according to an embodiment. FIG. 10 is a diagram illustrating an operation in which the moving plate returns to an original position of the moving plate to be aligned after an object is picked up in a platform system, according to an embodiment.

Hereinafter, an operation of picking up the object O from the station 102 using the manipulator 104 in the platform system 100 is described as an example with reference to FIGS. 1 and 8 to 10. Referring to FIG. 1, the manipulator 104 may move from the initial position of the manipulator 104 to the station 102 in which the object O (e.g., a tray on which vials are disposed) is placed, and the manipulator 104 may move based on, for example, SLAM. Referring to FIG. 8, the manipulator 104 may include a gripper 103 that has an inclined surface 105. The manipulator 104 may pick up the object O placed on the moving portion 106 using the gripper 103 and moving the gripper 103 in the direction D1. When the object O is picked up by the gripper 103, an external gravitational force FG may act on the gripper 103 due to the weight of the object O.

Referring to FIG. 9, the force may be transferred to the moving portion 106 along the inclined surface 105 of the gripper 103, and the moving portion 106 may move in the plane direction of the guide 112. That is, the moving portion 106 may move in direction P1 and direction P2.

Referring to FIG. 10, when the manipulator 104 lifts the object O using the gripper 103 such that the object O leaves the guide column 110, the aligner 116 may return the moving portion 106 to its original position. The plunger 132 may fix the position of the moving portion 106 when the moving portion 106 is in the original position. Thus, through a position adjustment function of the station 102, stable pickup of the object O by the manipulator 104 may be performed even when a position error of the manipulator 104 with respect to the station 102 occurs. One of ordinary skill in the art will understand from the disclosure herein that stable placement of the manipulator 104 is also achieved in a similar manner.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A platform system comprising:
a station comprising:
a moving portion; and
a guide configured to guide movement of the moving portion, and
a manipulator configured to pick up an object from the moving portion or to place the object on the moving portion,
wherein the moving portion is configured to move in response to the manipulator picking up the object from the moving portion or placing the object on the moving portion.

2. The platform system of claim 1, wherein the moving portion is further configured to move in a plane direction of the guide.

3. The platform system of claim 1, wherein the moving portion comprises a first plate.

4. The platform system of claim 3, wherein the guide comprises a second plate.

5. The platform system of claim 1, wherein the moving portion comprises a guide column.

6. The platform system of claim 1, wherein the moving portion is further configured to move from an original position, and
wherein the guide comprises an aligner configured to align the moving portion in the original position.

7. The platform system of claim 6, wherein the aligner comprises an elastic portion.

8. The platform system of claim 1, wherein the guide comprises a stopper configured to absorb shock from a collision of the moving portion with the stopper.

9. The platform system of claim 1, wherein the moving portion is further configured to move from an original position, and
wherein the guide comprises a plunger configured to fix a position of the moving portion to the original position.

10. The platform system of claim 1, further comprising:
a roller between the moving portion and the guide.

11. The platform system of claim 1, wherein the manipulator is configured to move relative to the station.

12. The platform system of claim 1, wherein the manipulator comprises a gripper configured to grip the object, the gripper having an inclined surface.

13. A station comprising:
a moving portion on which an object is placed, the moving portion being configured to move in response to the object being picked up from the moving portion or in response to the object being placed on the moving portion; and
a guide configured to guide movement of the moving portion.

14. The station of claim 13, wherein the moving portion is further configured to move in a plane direction of the guide.

15. A manipulator comprising:
a gripper configured to grip an object, the gripper having an inclined surface,
wherein the manipulator is configured to pick up the object from a station or place the object on the station using the gripper.

16. The manipulator of claim 15, wherein the manipulator is further configured to move relative to the station.
